(19) United States
(12) Patent Application Publication
(10) Pub. No.: US 2007/0108713 A1
(43) Pub. Date: May 17, 2007

(54) Rolling utility knife

(76) Inventor: Javid Ali, Mahomet, IL (US)

Correspondence Address: Matthew G. McKinney, Esq., Suite 150, 338 W. Morse Blvd., Winter Park, FL, 32789, US

(21) Appl. No.: 11/584,092

(22) Filed: Oct. 20, 2006

Related U.S. Application Data
(60) Provisional application No. 60/736,966, filed on Nov. 15, 2005.

(51) Int. Cl. B60G 9/00; B60G 1/04

(52) U.S. Cl. 280/124.11

(57) ABSTRACT

A carriage mechanism for use in cutting materials that increases the efficiency of a user and also reduces waste by improving the accuracy of a cut. The mechanism includes a frame having a front pair of apertures and a rear pair of apertures. A front axle is secured to the frame by the front pair of apertures and a rear axle is similarly secured. A pair of front wheels are rotatably mounted to the front axle and a pair of rear wheels are rotatably mounted to the rear axle. A blade is removably and adjustably mounted to the frame so that the blade can be extended from the frame to a preselected depth for cutting as the mechanism is rolled in a straight line path.

### 1. CROSS-REFERENCED TO RELATED APPLICATIONS

This application claims the benefit of U.S. Provisional Application No. 60/736,966 filed Nov. 15, 2005. The disclosure of the provisional application is incorporated herein by reference.

### 2. FIELD OF THE INVENTION

The present invention relates generally to utility knives, and more specifically to a novel carriage for a utility knife that provides for improved accuracy and consistency in cutting materials.

### 3. DESCRIPTION OF THE PRIOR ART

Utility knives are used every day for general purposes such as cutting paper, cartons, packages, cloth, twine, and envelopes. The prior art utility knives are typically sufficient for making short cuts. However, construction workers use utility knives to cut dry wall, wall paper or carpet, for example, that requires relatively long straight consistent cuts. The failure to make a straight cut results in waste and poor workmanship.

Another shortcoming of the prior art utility knives is that the amount of pressure applied by an inexperienced user when making a cut is not consistent. This leads to either a cut that is too shallow and incomplete or a cut that is too deep and damages the underlying material. Accordingly, what is needed in the art is a utility knife that can apply constant pressure to the blade regardless of the user's skill.

There are numerous utility knives on the market today that are variations from the standard fixed blade utility knife. Continuing efforts are being made to improve utility knives. By way of example, note U.S. Pat. No. 4,868,985 to Rehm that discloses a utility knife that provides for a blade that extends out of the housing when beginning a cut and automatically retracts at the end of the cutting operation. Rehm is directed to the safety of a user and the device itself to avoid personal injuries. It is not directed to improved accuracy and consistency in cutting as the present invention.

U.S. Pat. No. 4,884,342 to McNamara et al. discloses a utility knife with a wheel that is displaced proximate to the blade. The wheel is used to guide the blade over the cutting surface. However, the aforementioned teachings do not provide a mechanism by which a user can make a long straight cut in the field of a planar material or is adaptable to be used with a variety of tools other than a knife.

Notwithstanding the existence of such prior art utility knives, there is a need for an improved utility knife that will provide improved accuracy and consistency in cutting to increase efficiency and reduce waste.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### SUMMARY OF THE INVENTION

This invention is a carriage mechanism for cutting materials comprising a rectangular shaped frame forming an interior open space, a front pair of apertures comprising a first and second aperture opposingly disposed on a front portion of said frame, a rear pair of apertures comprising a third and forth aperture opposingly disposed on a rear portion of said frame, a front axle having a first end disposed within said first aperture of said front pair of apertures and a second end of said front axle disposed within said second aperture of said front pair of apertures, a rear axle having a first end disposed within said third aperture of said rear pair of apertures and a second end of said rear axle disposed within said fourth aperture of said rear pair of apertures, a pair of wheels rotatably mounted to said front axle, a pair of rear wheels rotatably mounted to said rear axle, and a blade removable and adjustably mounted to said frame so that said blade can be extended from said frame to a preselected depth for cutting as said mechanism is rolled in a straight line path and cannot deviate from said path because of the arrangement of said aforementioned elements.

It is therefore an object of the present invention to provide for an improvement that overcomes the aforementioned inadequacies of the prior art and provide a significant contribution to the advancement of utility knives.

Another object of the present invention is to provide a mechanism that increases precision in scoring or cutting materials.

Another object of the present invention is to provide a mechanism so that an inexperienced user can make straight cuts of materials with ease.

Another object of the present invention is to provide a mechanism for a utility knife that travels in straight-line motion and does not deviate from its desired path.

Another object of the present invention is to provide a mechanism that may be used within a track, independently, or with a straight edge.

Another object of the present invention is to provide a mechanism with an ergonomic design that allows a user to use the utility knife for extended periods of time without fatigue.

Still another object of the present invention is to provide a mechanism that can be used with various types of knifes or blades and can also be used with power tools such as circular saws and rotozips, as well as angle grinders, routers, and sanders.

Yet another object of the present invention is to provide a mechanism that is adaptable for use with hand raspers, saws, chisels and other similar hand tools.

Another object of the present invention is to provide a mechanism that is adaptable for use with a writing instrument so that straight lines can be sketched on a desired material.

Both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective view of an embodiment of the present invention;

FIG. 2 is a top view of an embodiment of the present invention;

FIG. 3 is a side elevation view of an embodiment of the present invention; and

FIG. 4 is a front elevation view of an embodiment of the present invention.

### DETAILED DESCRIPTION OF THE PREFERRED EMBODIMENT

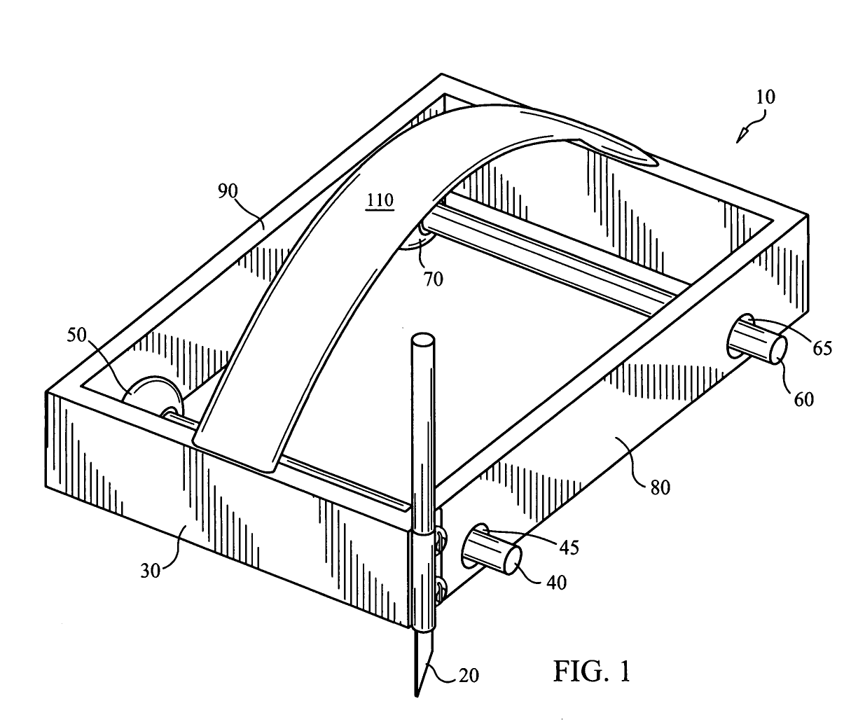

FIG. 1 shows the present rolling utility knife that comprises generally a rolling carriage 10. A blade 20 is removably mounted on the exterior of a frame 30. The blade 20 is positioned so that as the rolling carriage 10 is moved forward, the blade 20 makes a cut or incision into the construction material (not shown). The rolling carriage 10 travels in straight-line motion and remains in alignment. In the preferred embodiment, a first axle 40 and a first pair of wheels 50 comprise a front rolling assembly and second axle 60 and a second pair of wheels 70 comprise a rear rolling assembly. The front and rear rolling assemblies are constructed so that the rolling carriage 10 can not deviate from its desired path. The rolling carriage 10 may be used within a track, independently, or with a straight edge.

The rectangular frame 30 forms an interior open space within the carriage 10. A first side member 80 and second side member 90 of the frame 30 each further comprise a pair of front apertures 45 and a pair of rear apertures 65 that are disposed substantially equidistantly on each opposing side of the frame 30 that serve as bushings for the axles 40, 60. A first aperture of the pair of front apertures 45 receive a first end of axle 40 and a second aperture of the pair of front apertures 45 on the opposing side of the frame 30 receives the second end of the axle 40. Each axle 40, 60 is perpendicular to its respective side of the frame 30 and protrudes through the respective pair of apertures 45, 65.

In the preferred embodiment, the carriage 10 further comprises a handle 110 that is attached to the rear and front edges of the frame 30. The position of the handle 110 allows the user to grip the handle 110 in an ergonomic fashion when moving the carriage 10 forward (or backward).

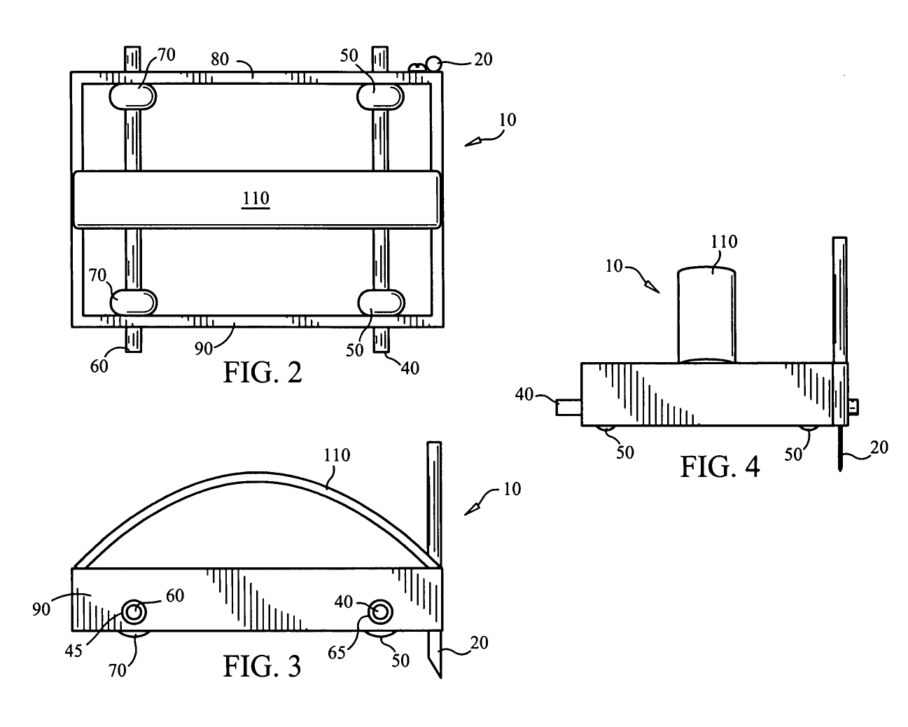

As shown in FIGS. 2 and 3, the present invention comprises a pair of wheels 50, 70 secured to each axle 40, 60 that allows the carriage assembly to roll. The wheels 50, 70 are mounted to their respective axle 40, 60 on the interior side of the frame 30. Alternatively, the wheels are mounted on the exterior side of the frame 30. The wheels 50, 70 are mounted proximate to the sides of the frame 30 to provide stability to the rolling carriage 10 as it moves. The wheels 50, 70 mounted proximate to the second side member 90 of the frame 30 on the front axle 40 and rear axle 60 are in alignment with one another. Similarly, the wheels 50, 70 mounted proximate to the first side member 80 of the frame 30 on the front axle 40 and rear axle 60 are in alignment with one another.

FIG. 4 depicts a front view of the mechanism showing blade 20 protruded below the wheels 50. Blade 20 is adjustable by the user to provide a preselected depth of the cut into the desired material.

In an alternative embodiment, a laser device (not shown) is attached to the rolling carriage 10 to provide a visual aid to maintain the straight-line cutting motion of the invention. The present invention can be used with various types of knifes or blades and is not intended to be limited by the drawings. The rolling carriage 10 can also be used with optional tools such as circular saws and rotozips, as well as angle grinders, routers, and sanders. The rolling carriage 10 is adaptable for use with hand raspers, saws, chisels and other similar hand tools. Further, a writing instrument can be attached to the rolling carriage 10 to sketch straight lines on a desired material. An attachment means comprises an adjustable bracket to secure an optional tool to the carriage.

In yet another embodiment, solid cylindrical rollers are used in place of the axels 40, 60 and wheels 50, 70. Each roller comprises a cylindrical member with a countersunk recess located on a first end and second of the roller. A biasing means of the frame 30 used in conjunction with the countersunk recesses allows free rotation motion of each roller.

In alternative embodiments, the invention is not limited to two axles or cylindrical rollers but comprises from one to three or more axles or cylindrical rollers depending on a particular application.

The particular embodiments disclosed above and in the drawings are illustrative only, as the invention may be modified and practiced in different but equivalent manners apparent to those skilled in the art having the benefit of the teachings herein. Furthermore, no limitations are intended to the details of construction or design herein shown. It is therefore evident that the particular embodiments disclosed above may be altered or modified and all such variations are considered within the scope and spirit of the invention.

It is also to be understood that the following claims are intended to cover all of the generic and specific features of the invention herein described, and all statements of the scope of the invention, which as a matter of language, might be said to fall therebetween.

Now that the invention has been described,

What is claimed is:

1. A carriage mechanism for cutting materials comprising:
a rectangular shaped frame forming an interior open space;
a front pair of apertures comprising a first and second aperture opposingly disposed on a front portion of said frame;
a rear pair of apertures comprising a third and forth aperture opposingly disposed on a rear portion of said frame;
a front axle having a first end disposed within said first aperture of said front pair of apertures and a second end of said front axle disposed within said second aperture of said front pair of apertures;
a rear axle having a first end disposed within said third aperture of said rear pair of apertures and a second end of said rear axle disposed within said fourth aperture of said rear pair of apertures;
a pair of front wheels rotatably mounted to said front axle; and
a pair of rear wheels rotatably mounted to said rear axle.

2. The mechanism of claim 1 wherein said pair of front wheels is rotatably mounted on said front axle on an interior side of said frame.

3. The mechanism of claim 1 wherein said pair of rear wheels is rotatably mounted on said rear axle on an interior side of said frame.

4. The mechanism of claim 1 further comprising a blade removable and adjustably mounted to said frame so that said blade can be extended from said frame to a preselected depth for cutting as said mechanism is rolled in a straight line path and cannot deviate from said path because of the arrangement of said aforementioned elements.

5. The mechanism of claim 1 wherein said pair of rear wheels is rotatably mounted on said rear axle on an interior side of said frame.

6. The mechanism of claim 1 further comprises a handle attached to a front edge and a rear edge of said frame.

7. The mechanism of claim 1 further comprising a laser means attached to said frame so that a visual aid is provided to the user to maintain a desired path as said mechanism is in motion.

8. The mechanism of claim 1 further comprising a writing instrument removable and adjustably mounted to said frame so that a straight line path can be marked on preselected material using said writing instrument as said mechanism is rolled in motion.

9. The mechanism of claim 1 further comprising an attachment means to removably attach an electric circular saw to said frame so that a straight line path cut can be completed on preselected material as said mechanism is rolled in motion.

10. The mechanism of claim 1 further comprising an attachment means to removably attach an electric router to said frame so that said router follows a straight line path on preselected material as said mechanism is rolled in motion.

11. The mechanism of claim 1 further comprising an attachment means to removably attach a hand chisel to said frame so that said chisel follows a straight line path on preselected material as said mechanism is rolled in motion.

12. A carriage mechanism for cutting materials comprising:
a rectangular shaped frame forming an interior open space;
a front cylindrical roller having a first end with a countersunk recess and a second end of said front cylindrical roller having a second end with a countersunk recess;
a front biasing means disposed on a front portion of said frame removably engaged with said front cylindrical roller so that said countersunk recesses allow free rotation of said front cylindrical roller;
a rear cylindrical roller having a first end with a countersunk recess and a second end of said rear cylindrical roller having a second end with a countersunk recess; and
a rear biasing means disposed on a rear portion of said frame removably engaged with said rear cylindrical roller so that said countersunk recesses allow free rotation of said rear cylindrical roller.

13. The mechanism of claim 12 further comprises a handle attached to a front edge and a rear edge of said frame.

14. The mechanism of claim 12 further comprising a laser means attached to said frame so that a visual aid is provided to the user to maintain a desired path as said mechanism is in motion.

15. The mechanism of claim 12 further comprising a writing instrument removable and adjustably mounted to said frame so that a straight line path can be marked on preselected material using said writing instrument as said mechanism is rolled in motion.

16. The mechanism of claim 12 further comprising an attachment means to removably attach an electric circular saw to said frame so that a straight line path cut can be completed on preselected material as said mechanism is rolled in motion.

17. The mechanism of claim 12 further comprising an attachment means to removably attach an electric router to said frame so that said router follows a straight line path on preselected material as said mechanism is rolled in motion.

18. The mechanism of claim 12 further comprising an attachment means to removably attach a hand chisel to said frame so that said chisel follows a straight line path on preselected material as said mechanism is rolled in motion.

19. A carriage mechanism for cutting materials comprising:
a rectangular shaped frame forming an interior open space;
a front pair of apertures comprising a first and second aperture opposingly disposed on a front portion of said frame;
a rear pair of apertures comprising a third and forth aperture opposingly disposed on a rear portion of said frame;
a front axle having a first end disposed within said first aperture of said front pair of apertures and a second end of said front axle disposed within said second aperture of said front pair of apertures;
a rear axle having a first end disposed within said third aperture of said rear pair of apertures and a second end of said rear axle disposed within said fourth aperture of said rear pair of apertures;
a pair of front wheels rotatably mounted to said front axle wherein said pair of front wheels is rotatably mounted on said front axle on an interior side of said frame;
a pair of rear wheels rotatably mounted to said rear axle wherein said pair of rear wheels is rotatably mounted on said rear axle on an interior side of said frame; and
a blade removable and adjustably mounted to said frame so that said blade can be extended from said frame to a preselected depth for cutting as said mechanism is rolled in a straight line path and cannot deviate from said path because of the arrangement of said aforementioned elements.

20. The mechanism of claim 19 further comprises a handle attached to a front edge and a rear edge of said frame.
